(19) United States
(12) Patent Application Publication
(10) Pub. No.: US 2020/0080586 A1
(43) Pub. Date: Mar. 12, 2020

(54) INTERMEDIATE SHEET

(71) Applicant: MTU Aero Engines AG, Munchen (DE)

(72) Inventor: Karl-Heinz Dusel, Unterschleissheim (DE)

(73) Assignee: MTU Aero Engines AG, Munchen (DE)

(21) Appl. No.: 16/564,601

(22) Filed: Sep. 9, 2019

(30) Foreign Application Priority Data
Sep. 10, 2018 (DE) 10 2018 215 360.4

(51) Int. Cl. F16B 43/00; B33Y 80/00

(52) U.S. Cl. CPC F16B 43/00; B33Y 80/00

(57) ABSTRACT

The present invention relates to a one-piece intermediate sheet having a first layer that has a first outer surface with a first outer surface region, and a second layer that is integrally formed with the first layer and has a second outer surface with a second outer surface region, wherein the first and second outer surfaces form opposite-lying, in particular parallel, outer surfaces of the intermediate sheet, and the hardness of the first outer surface region is smaller than the hardness of the second outer surface region, and/or the modulus of elasticity of the first layer is smaller than the modulus of elasticity of the second layer.

### BACKGROUND OF THE INVENTION

The present invention relates to a one-piece intermediate sheet, the manufacture and use thereof, as well as a component arrangement having the intermediate sheet.

Intermediate sheets are arranged as washers, for example, between a screw head or a nut and an outer surface of a component to be screwed.

In particular, if this component is cast or additively manufactured, up to now, a contact region of its initially rough outer surface must frequently be post-processed by machining in order to create a smooth bearing surface for the washer.

### SUMMARY OF THE INVENTION

An object of one embodiment of the present invention is to provide an improved intermediate sheet or an improved component arrangement having at least one intermediate sheet.

This object is achieved by an intermediate sheet and a component arrangement having one or more of the intermediate sheets described here or the manufacture or use of an intermediate sheet described here in accordance with the present invention. Advantageous embodiments of the invention are discussed in detail below.

According to one embodiment of the present invention, a one-piece or one-part intermediate sheet has a first layer with a first outer surface (of the intermediate sheet) and a second layer that is or will be formed integrally with the first layer and having a second outer surface, wherein the first and second outer surfaces form opposite-lying outer surfaces, which are parallel in one embodiment, of the intermediate sheet, and the first outer surface has a first outer surface region and the second outer surface has a second outer surface region. The first outer surface region can comprise a part of the first outer surface or also can be the entire first outer surface; the second outer surface region can comprise a part of the second outer surface or also can be the entire second outer surface.

According to one embodiment of the present invention, the hardness of the first outer surface region is smaller than the hardness of the second outer surface region; in one embodiment, the hardness of the first outer surface region amounts to at most 90%, particularly at most 75%, in one embodiment at most 50%, of the hardness of the second outer surface region.

Additionally or alternatively, according to one embodiment of the present invention, the modulus of elasticity of the first layer is smaller than the modulus of elasticity of the second layer; in one embodiment, the modulus of elasticity of the first layer amounts to at most 90%, in particular at most 75%, in one embodiment at most 50%, of the modulus of elasticity of the second layer.

In one embodiment, in each case, particularly in combination, the first outer surface region advantageously can compensate, at least partially thereby, for non-uniformities of an outer surface, in particular an outer surface that has not been post-processed, of a first component of a component arrangement, in one embodiment elastically and/or plastically, and simultaneously, in contrast, the second outer surface region can provide a harder or more rigid support for a second component of the component arrangement.

In one embodiment, in particular, a machining post-processing for the manufacture of a smooth bearing surface on the first component can be eliminated thereby, and/or forces, in particular friction forces and/or compressive forces can be better transferred or distributed, particularly more homogeneously. In one embodiment, a form fit with (uneven places of) the first component or the contact surface or outer surface thereof can be or will be able to be realized by elastic and/or plastic deformation of the first layer or of the first outer surface region.

The hardness of an outer surface region is to be understood in the present case, particularly in technical terms, as the mechanical resistance which that the mechanical penetration of a foreign object into this surface region.

Correspondingly, in one embodiment (the hardness of the first and second outer surface regions is such that) the compressive force that is necessary in order to press a test specimen, in particular a hard metal or carbide ball that presses against the first outer surface region, the ball preferably having a diameter of 10 mm, 5 mm, 2.5 mm or 1 mm, to a predefined extent, in particular 0.1 mm, 0.5 mm, 1 mm or 2 mm, into this outer surface region or into the first layer, (is) smaller than the compressive force that is necessary in order to press the same test specimen against the second outer surface region by the same predefined extent into this outer surface region or the second layer; in particular, the compressive force is smaller (by) at least 25%, in one embodiment (by) at least 50%.

The hardness of the first and second outer surface regions is measured in one embodiment with the same measurement method, in particular at the same temperature, in one embodiment at 20° C., and/or according to DIN EN ISO 14577, DIN EN ISO 6508-1, EN ISO 6506-1 to EN ISO 6506-4 or DIN EN ISO 6507-1:2005 to -4:2005; in particular, it can be the Martens or Universal hardness.

In one embodiment, one or a plurality of additional layers is or are arranged between the first layer and the second layer, whereby, in one embodiment, the force distribution can be (further) improved. In particular, at least one of these layers can have a modulus of elasticity that is different from the modulus of elasticity of the first layer and the modulus of elasticity of the second layer.

In another embodiment, first and second layers bound one another or are adjacent to one another, whereby, in one embodiment, the intermediate sheet can be flat (even).

In one embodiment, in particular, the minimum, maximum, and/or mean layer thickness of the first layer amounts to at least 50%, in one embodiment, at least 100%, in particular at least 150%, and/or at most 200%, in particular at most 150%, in one embodiment at most 100%, in particular at most 50%, of the particularly minimum, maximum, and/or mean layer thickness of the second layer.

In one embodiment, the first layer and/or the second layer and in one embodiment the intermediate sheet is/are or will be manufactured by means of additive manufacturing or a generative manufacturing process, in which, in one embodiment, the intermediate sheet or the first and/or second layer(s) will be produced in strata by local solidification of free-flowing initial material, and joining to a stratum lying underneath.

In this way, in one embodiment, the first and second layers can be integrally formed with one another in a particularly advantageous manner, and/or different hardness(es) or moduli of elasticity can be realized.

In one embodiment, the first and second layers, and particularly the intermediate sheet is/are or will be manufactured from the same material, in particular metal and/or plastic. In this case, different hardness(es) or moduli of elasticity are realized, in particular, by correspondingly (varied) parameters of the additive manufacturing or the generative manufacturing process.

In one embodiment, the first and second layers can be manufactured particularly rapidly and/or homogeneously.

In one embodiment, the different hardnesses or moduli of elasticity are produced with the same or different materials for the first and second layers based on a difference in the layer structure and/or surface structure, particularly based on a different material arrangement and/or a different porosity. For example, the first layer can have a higher porosity than the second layer, for example, due to a net-like or reticular structure, and/or can have deformable surface structures such as filigree webs or projections.

In another embodiment, the first and second layers, particularly the intermediate sheet comprises or comprise different materials, in particular metals and/or plastics. This can be provided in particular by a change of material in both additive manufacturing or during the generative manufacturing process.

In one embodiment, the first and second layers can be manufactured in a particularly reliable process and/or hardnesses or moduli of elasticity can be greatly varied thereby.

The first layer and/or second layer (in each case) may have a plurality of additively manufactured strata or may also be composed of a single additively manufactured stratum.

In one embodiment, the mean roughness value Ra according to DIN EN ISO 4287:2010 for the second outer surface region amounts to at most 3 μm, in particular, at most 1 μm. In other words, in one embodiment, the second outer surface region is smooth.

In this way, in one embodiment, a particularly advantageous bearing surface can be provided for the second component, and/or the transfer of force between the second component and the intermediate sheet can be (further) improved.

In one embodiment, the thickness of the intermediate sheet, in particular the minimum, maximum and/or mean thickness, (measured) perpendicular to the first and/or second outer surface, amounts to at most 15%, in particular to at most 10%, of the square root of the surface area of this outer surface. In other words, in one embodiment, the intermediate sheet is flat.

In one embodiment, a particularly compact component arrangement can be realized in this way.

In one embodiment, the first layer and/or the second layer, in particular the intermediate sheet, has or have at least one through-borehole. Additionally or alternatively, the first layer and/or the second layer, particularly the intermediate sheet, has or have a circular-shaped outer contour. In particular, the intermediate sheet can thus form a washer, which represents a particularly advantageous use, but without limiting the invention thereto.

According to one embodiment of the present invention, a component arrangement has one first component, which is manufactured in one embodiment by means of casting or additive manufacturing, and one second component, which is connected to the first component, in particular clamped thereto, in one embodiment screwed or riveted thereto, particularly in a friction fit and/or nondestructive detachable manner, this second component particularly being a connection element, in one embodiment a screw (screw head), a nut, a rivet (rivet head) as well as at least one intermediate sheet described here, which is disposed so that or in such a way that it is or will be compressed elastically and/or plastically between the first and second components, especially is clamped by the first and second components in one embodiment, so that it contacts an outer surface of the first component by its first outer surface region, and an outer surface of the second component by its second outer surface region, and in one embodiment, makes a flat contact.

In one embodiment, the mean roughness value Ra according to DIN EN ISO 4287:2010 of the outer surface of the first component contacting the first outer surface region of the intermediate sheet is larger (by) at least 1 μm than the mean roughness value Ra according to DIN EN ISO 4287:2010 of the second outer surface region, and/or amounts to at least 4 μm.

Advantageously, in one embodiment, nonuniformities of the outer surface of the first component can be compensated for particularly advantageously in this way, at least partially, and in one embodiment elastically and/or plastically, and/or at the same time a smooth (smoother) bearing surface can be provided for the second component.

In one embodiment, the second layer is formed before the first layer, particularly in the case of additive manufacturing.

In one embodiment, the additive manufacturing, in particular its process reliability and/or its speed can be improved in this way.

In one embodiment, the second outer surface region, in particular the second outer surface can be or will be able to be manufactured by means of erosion, in particular wire erosion. In particular, if the first and second layers are or will be additively manufactured, they can be detached or separated in common by means of (wire) erosion along a boundary of the second layer, for example, from a platform of a device for additive manufacturing or from another section of material that is additively manufactured in common.

By means of erosion, the intermediate sheet can be separated and, simultaneously, a particularly smooth surface can be manufactured without necessitating another post-processing.

### BRIEF DESCRIPTION OF THE DRAWING FIGURES

Additional advantageous enhancements of the present invention can be taken from the dependent claims and the following description of preferred embodiments. For this purpose and partially schematized:

FIG. 1 shows one step of a method for manufacturing an intermediate sheet according to one embodiment of the present invention;

FIG. 2 shows a further step of the method; and

FIG. 3 shows a component arrangement with the intermediate sheet or the use thereof according to one embodiment of the present invention.

### DESCRIPTION OF THE INVENTION

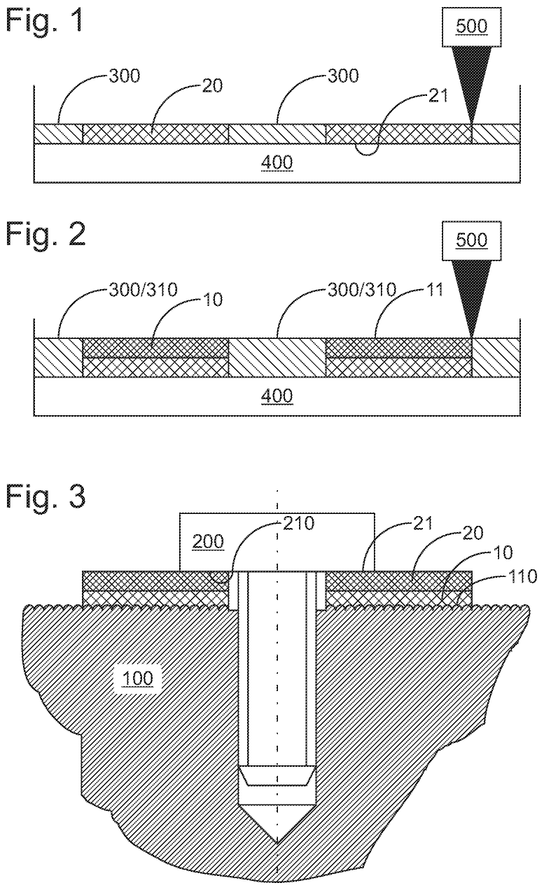

FIG. 1 shows one step of a method for manufacturing an intermediate sheet according to one embodiment of the present invention.

In a way known in and of itself, a free-flowing initial material 300 is arranged in strata on a platform 400 and locally solidified, for example, by a laser 500, in order to initially form a second layer 20 of an intermediate sheet, which forms a second outer surface 21 of the intermediate sheet, which represents a second outer surface region.

In a subsequent method step indicated in FIG. 2, in one embodiment, the same free-flowing initial material 300 is arranged in strata on the second layer 20 and locally solidified, in order to form a first layer 10 of the intermediate sheet, which forms a first outer surface 11 of the intermediate sheet, which represents a first outer surface region.

In this case, parameters of this additive manufacturing are varied in such a way that the hardness of the first outer surface region 11 is smaller than the hardness of the second outer surface region 21, and/or the modulus of elasticity of the first layer 10 is smaller than the modulus of elasticity of the second layer 20.

In another embodiment, in the method step indicated in FIG. 2, another free-flowing initial material 310 is arranged in strata on the second layer 20 and locally solidified, in order to form the first layer 10 of the intermediate sheet, which forms the first outer surface 11 of the intermediate sheet, which represents the first outer surface region.

After removing the unsolidified initial material and after removal of the platform, the washer that is additively manufactured in this way is arranged between a first component 100 and a second component in the form of a screw or a screw head 200 thereof, wherein the screw is screwed into the first component via a through-borehole of the washer.

As is shown in an exaggerated manner in FIG. 3, the untreated outer surface 110 of the first component is rough. This unevenness, however, is advantageously compensated by the softer first layer 10 or the outer surface (outer surface region) 11, and at the same time, the outer surface 210 of the screw (screw head) is provided with a hard, smooth bearing surface in the form of the second outer surface (outer surface region) 21.

The post-processing of the outer surface 110 can be eliminated thereby and a force distribution or force line can be improved.

Although exemplary embodiments were explained in the preceding description, it shall be noted that a plurality of modifications is possible.

In addition, it shall be noted that the exemplary embodiments only involve examples that in no way shall limit the scope of protection, the applications and the construction. Rather, a guide is given to the person skilled in the art by the preceding description for implementing at least one exemplary embodiment, whereby diverse changes, particularly with respect to the function and arrangement of the described components, can be carried out without departing from the scope of protection, as it results from the claims and combinations of features equivalent to these.

1. An intermediate sheet, comprising a first layer that has a first outer surface with a first outer surface region, and a second layer that is integrally formed with the first layer and has a second outer surface with a second outer surface region, wherein the first and second outer surfaces form parallel opposite-lying outer surfaces of the intermediate sheet, and the hardness of the first outer surface region is smaller than the hardness of the second outer surface region, and/or the modulus of elasticity of the first layer is smaller than the modulus of elasticity of the second layer.

2. The intermediate sheet according to claim 1, wherein the smaller hardness or the smaller modulus of elasticity of the first outer surface region results due to a difference in the layer structure and/or surface structure, due to a different material arrangement and/or a different porosity.

3. The intermediate sheet according to claim 1, wherein the first and/or second layer(s) are manufactured by additive manufacturing, and/or the second outer surface is produced by erosion.

4. The intermediate sheet according to claim 1, wherein the first and second layers are manufactured from the same material or comprise different materials.

5. The intermediate sheet according to claim 1, wherein the mean roughness value Ra according to DIN EN ISO 4287:2010 of the second outer surface region is at most 3 μm.

6. The intermediate sheet according to claim 1, wherein the thickness of the intermediate sheet perpendicular to the first and/or second outer surface(s) is at most 15% of a square root of the surface area of this outer surface.

7. The intermediate sheet according to claim 1, wherein the first and/or second layer(s) has or have at least one through-borehole and/or a circular-shaped outer contour.

8. The intermediate sheet according to claim 1, wherein at least one intermediate sheet is configured and arranged into a component arrangement having a first component, which is manufactured by casting or additive manufacturing, and a second component, which is joined to the first component, in a friction fit and/or nondestructive detachable manner wherein the at least one intermediate sheet is arranged between the first and second components so that it contacts an outer surface of the first component by its first outer surface region, and an outer surface of the second component by its second outer surface region to make a flat contact.

9. The intermediate sheet according to claim 8, wherein the mean roughness value Ra according to DIN EN ISO 4287:2010 of the outer surface of the first component contacting the first outer surface region of the intermediate sheet is at least 1 μm larger than the mean roughness value Ra according to DIN EN ISO 4287:2010 of the second outer surface region, and/or amounts to at least 4 μm.

10. The intermediate sheet according to claim 1, wherein the intermediate sheet is arranged between the two outer surfaces facing one another of the two components of a component arrangement.

11. The intermediate sheet according to claim 1, wherein the second layer is integrally formed with and before the first layer by additive manufacturing.

12. The intermediate sheet according to claim claim 11, wherein the second outer surface region is manufactured by separating the additively manufactured first and second layers by along a boundary of the second layer.
